(19) United States
(12) Patent Application Publication
(10) Pub. No.: US 2023/0267520 A1
(43) Pub. Date: Aug. 24, 2023

(54) SYSTEMS AND METHODS FOR AUTOMATICALLY PREDICTING FUTURE EVENTS

(71) Applicant: Morgan Stanley Services Group Inc., New York, NY (US)

(72) Inventors: Joseph SCHIAVONE, Piscataway, NJ (US); Samuel VACCARO, Norwalk, CT (US); Alexander LYUDIN, Staten Island, NY (US)

(73) Assignee: Morgan Stanley Services Group Inc., New York, NY (US)

(21) Appl. No.: 17/675,524

(22) Filed: Feb. 18, 2022

(51) Int. Cl. G06Q 30/06

(52) U.S. Cl. CPC G06Q 30/06

(57) ABSTRACT

System and methods for determining predicting future events based on prior occurrences are provided. The systems and method can include a grouping a timeseries data set of prior occurrences that can have plurality of fields by a time and date field, and other fields. A set of factors can be determined based on the occurrences, and the set of factors can be used to predict future events.

### FIELD OF THE INVENTION

The invention relates generally to technology for automatic event prediction. In particular, the invention relates to automatic future event prediction based on prior occurrences of events.

### BACKGROUND OF THE INVENTION

Currently, systems and methods for predicting future events exist. For example, a personal financial management system may help consumers manage their spending by providing the user with a “safe to spend” or “need to reduce amount”. Some current systems compare prior average spending to a budget in order to present an average surplus or shortfall. Some current systems compare period-to-date spending to budget limits to give a current value.

A consumer can desire foresight into upcoming transactions, both scheduled and probable, to know if they can afford a discretionary expense. Though some current systems may allow the user to manually declare recurring payments to attempt to account for future obligations, manual entries are typically subject to human error can often fail to recognize the date upon which the payments actually occur.

As occurrences of events can occur in real-time, it can be difficult to make accurate estimates via batch processing. Accordingly, it can be desirable to provide accurate event prediction in real-time or near real-time.

### SUMMARY OF THE INVENTION

Another advantage of the invention can include an ability to provide event prediction in real-time or near real-time. Another advantage of the invention can include an ability to avoid double counting of occurrences due to, for example, real-time execution. Another advantage of the invention can include self-determined trusted attributes due to, for example, analyzing events independently. Another advantage of the invention can include self-adjusting in real-time predictions due to, for example, recognizing early or timely execution of anticipated transactions to, for example avoid double counting.

Another advantage of the invention can include an ability to provide accurate event prediction even when prior occurrences of events were late, have ended, when prior events change or any combination. Another advantage of the invention can include users gaining a better understanding of financial patterns and/or anomalies for predicted and/or unpredicted financial events.

In one aspect, the invention involves method for determining predicting future events based on prior occurrences. The method can involve receiving, by a computing device, a timeseries data set of prior occurrences, each prior occurrence having a plurality of fields including a time field, a date field or both. The method can involve grouping, by the computing device, all prior occurrences by the time field or the date field. The method can involve grouping, by the computing device, all prior occurrences by a first field of the plurality of fields. The method can involve tagging, by the computing device, all of the prior occurrences with a date that is the most recent prior incidence of an occurrence having a same field of the plurality of fields. The method can involve determining, by the computing device, for each same field of the plurality of fields, a set of factors, wherein the set of factors is based on date of the occurrence. The method can involve determining, by the computing device, one or more desired predicted future events, the one or more desired predicted future events based on the set of factors.

In some embodiments, the first field of the plurality of fields includes one or more fields that the prior occurrences are grouped by, one or more fields that are the same as the future event that are desired to predict, or any combination thereof. In some embodiments, the plurality of fields comprises a date, an amount, a category, or any combination thereof.

In some embodiments, the prior occurrences are prior transactions and further comprising summing, by the computing device, an amount for each group of prior transactions on a single date to create a group of single date transactions that includes one transaction per date and one amount per date.

In some embodiments, the set of factors is further based on occurrence type, transaction type, event type, or any combination thereof. In some embodiments, the plurality of fields includes a merchant.

In some embodiments, the prior occurrences are prior transactions and wherein the set of factors includes a number of transactions, an average of all transactions for the merchant, a variance for all transactions of the merchant, an average day span between transactions for the merchant, a variance for the average day span between transactions, a day of a week the transactions occurred, a variance in the day of the week the transaction occurred, a day of a month the transactions occurred, and a variance in the day of the week the transaction occurred, or any combination thereof.

In some embodiments, the desired projected future events include a projected repeat transaction amount, a transaction interval, or any combination thereof. In some embodiments, a transaction interval further comprises a particular day of the week or month projected for the transactions to occur.

In another aspect, the invention involves a method for determining predicting future events based on prior transactions. The method involves receiving, by a computing device, a timeseries data set of prior transactions, each prior transaction having a date, an amount, a category, a merchant, or any combination thereof. The method involves grouping, by the computing device, all prior transactions having the same date. The method involves tagging, by the computing device, all of the prior transactions with a date that is the most recent prior incidence of a transaction having a same merchant. The method involves determining, by the computing device, for each merchant, a set of factors based on the tagged prior transactions, wherein the set of factors includes a number of transactions, an average of all transactions for the merchant, a variance for all transactions of the merchant, an average day span between transactions for the merchant, a variance for the average day span between transactions, a day of a week the transactions occurred, a variance in the day of the week the transaction occurred, a day of a month the transactions occurred, and a variance in the day of the week the transaction occurred, or any combination thereof. The method involves determining, by the computing device, for each merchant a projected repeat transaction amount, a transaction interval, or any combination thereof based on the set of factors.

In some embodiments, the transaction interval further comprises a particular day of the week or month projected for the transactions to occur.

In some embodiments, the method involves summing, by the computing device, an amount for each group of prior transactions on a single date to create a group of single date transactions that includes one transaction per date and one amount per date.

In another aspect, the invention includes a non-transitory computer program product comprising instructions which, when the program is executed cause the program to receive a timeseries data set of prior occurrences, each prior occurrence having a plurality of fields including a time field, a date field or both, group all prior occurrences by the time field or the date field, group all prior occurrences by a first field of the plurality of fields, tag all of the prior occurrences with a date that is the most recent prior incidence of an occurrence having a same field of the plurality of fields, determine for each same field of the plurality of fields, a set of factors, wherein the set of factors is based on date of the occurrence, and determine one or more desired predicted future events, the one or more desired predicted future events based on the set of factors.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a block diagram of a system for automatically detecting future events according to an illustrative embodiment of the invention.

FIG. 2 is a flow diagram for a method for automatically detecting future events, according to an illustrative embodiment of the invention.

FIG. 3A and FIG. 3B are diagrams showing an example of automatically detecting future events for a particular user, according to an illustrative embodiment of the invention.

FIG. 4 is a block diagram of a computing device which can be used with embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

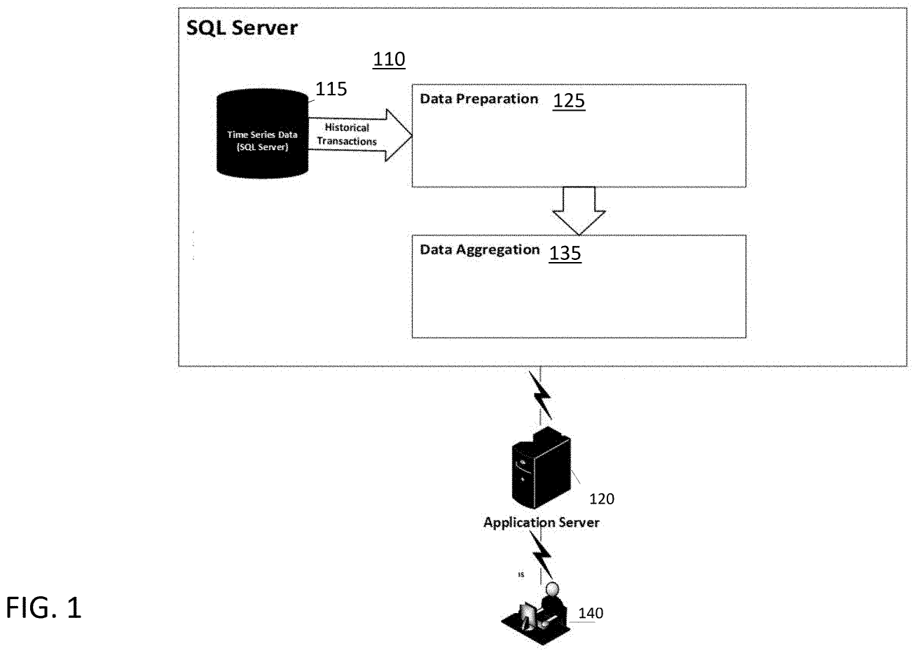

FIG. 1 is a block diagram of a system for automatically detecting future events according to an illustrative embodiment of the invention. The system 100 includes a SQL server 110 and an application server 120. The SQL server 110 can include a time series data database 115, a data preparation module 125 and a data aggregation module 135.

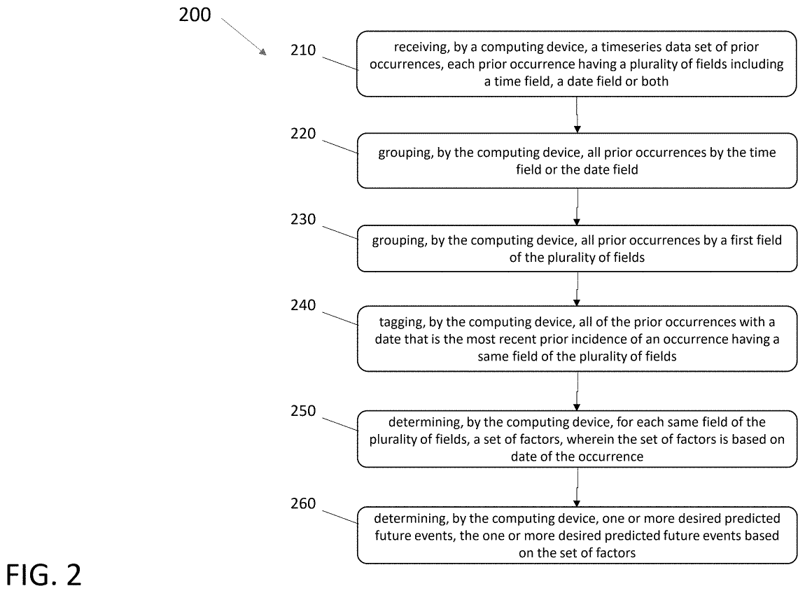

The application server 120 can receive one or more requests from a user 140 (or multiple users, not shown). The requests can be for automatic detection of future events. The detection of future events can be for predicting events that are likely to happen based on prior occurrences. The prior occurrences can be of the same events or different events or factors that indicate the events that are desired to predict. The requests can include a particular date range. For example, the request can include a range of one day, two weeks, or a particular date range (e.g., Jan. 1, 2021 through Jan. 3, 2021). The request can include a time range. The requests can depend upon a type of the event and/or a type of a prior occurrence as discussed in further detail below with respect to FIG. 2.

The application server 120 can transmit the one or more requests to the SQL server 110. The SQL server 110 can retrieve time series data from the time series data database 125. The time series data can be data that correlates to the type of the event to be predicted. For example, the request can be from a user to predict future financial transactions for a remainder of a month. The time series data retrieved from the time series data database 115 can be at any interval (e.g., seconds, hourly, daily, monthly, quarterly and/or years) financial transaction data for the particular user and/or for other users that have similar or the same financial transaction types as the user. For example, if a like transactions is identified for a subset of current users (e.g., television subscription users), and that like transaction also recurs regularly, then similar assumptions can be made for a new user who may not have enough instances to predict the next. In another example, for a new user with a like transaction or a new instance of that like transaction on an existing user, the transaction can be predicted as recurring and assigned a like periodicity with a date to happen next.

The time series data database 115 can provide the time series data to the data preparation module 125. The data preparation module 125 can prepare the time series data to be in a form that is ready to be processed for predictions. The preparation can include grouping by date, attributes, transaction types and/or other field as described below with respect to FIG. 2. The data preparation module 125 can provide the prepared time series data to the data aggregation module 135. The data aggregation module 135 can identify groups of similar transactions, perform a statistical analysis of the groups, use the statistics to predict recurrence patterns and/or predicted values of each group.

The application server 120 can be in bidirectional communication with the SQL server 110. The communication between the user 140, the application server 120 and/or the SQL server 110 can be over the wired or wireless. The wireless communication can be over the internet, for example, through wired/wireless connections as are known in the art.

In various embodiments, detected events can be output through with digital assistants (e.g., Ski, Alexa Cortana). In various embodiments, system can be implemented on and/or integrated with Cloud, AWS, and/or Azure technologies.

FIG. 2 is a flow diagram for a method 200 for automatically detecting future events, according to an illustrative embodiment of the invention, according to an illustrative embodiment of the invention.

The method can involve receiving, by a computing device (e.g., SQL server 110 as described above in FIG. 1), a timeseries data set (e.g., timeseries data 120 as described above in FIG. 1) of prior occurrences, each prior occurrence having a plurality of fields including a time field, a date field or both (Step 210).

The time field can indicate the time at which the prior occurrence occurred. The date field can indicate the date at which the prior occurrence occurred. The date field can include a day of the month, a day of the week, weekday vs. weekend and/or a number of days since a prior event.

In various embodiments, each prior occurrence includes one or more fields. The one or more fields can include time field, date field, and/or additional fields. The additional fields can depend upon a type of the event to be predicted as discussed in further detail below.

The time series data set of prior occurrences can be for a given type of event to be predicted. The type of the event to be predicted can be financial transactions. Prediction of financial transactions can include a projection of investment returns, projection of spending and/or a transaction interval. Financial transactions can include mortgage payments, payroll, dining, clothing payments, and/or any other type of purchases. The one or more fields for financial transactions in the time series data set can include a date, time, account, category type, merchant type, amount of transaction, or any combination thereof.

The type of the event to be predicted can be online technology transaction. Prediction of technology transactions can include a projection of user engagement with a website or mobile application. Online technology transactions can include, for example, 1) a user event visiting a website or mobile application, 2) user event leveraging a website to learn about a particular topic, and/or 3) user event use of an app to execute specific tasks. Online technology transactions can include any technology transaction as is known in the art. The one or more fields for technology transactions in the time series data set can include a date, time, hours of internet usage, web site types visited, previous and post websites visited, actions taken on the app, content viewed, comments/text entered or any combination thereof.

The type of the event to be predicted can be education-related events. Prediction of education events can include, for example, 1) a projection of school attendance, 2) projection of grades, and/or 3) projection of admission success based on similar people. Prediction of education events can include any type of education event as is known in the art. Education occurrences can include history of grades, history of attendance, history of extracurricular activities. The one or more fields for education events in the time series data set can include a date, time, grades, class type, activity type, attendance mark, or any combination thereof.

The type of the event to be predicted can be fitness events. Prediction of fitness events can include, for example, a projection of 1) user exercise frequency, 2) behavior when exercising (e.g., anticipated number of miles running, biking), 3) anticipating the user's biomarkers (e.g., resting heart rate and/or active heart rate) when engaging in exercise and/or 4) correlated ancillary result that happen in conjunction with exercise (e.g., additional minutes slept and/or number of calories eaten). Along with predicting the invention can signal to the user when something is not going as predicted (e.g., heart rate exceeding a safe range). Prediction of fitness events can include any fitness event as is known in the art. Fitness occurrences can include specific types of exercises, duration and distances covered, number of reps and sets when weight training as well as wellness metrics like calories burned, heart rate, oxygen saturation, sleep intervals and even adherence to a diet. The one or more fields for fitness transactions in the time series data set can include a date, time, exercise type, exercise length, exercise frequency, condition type, or any combination thereof.

The type of the event to be predicted can be a health event. Prediction of health events can include, for example, a projection of 1) refilling or consuming medications, 2) recurring doctor appointments and/or 3) procedures or recurrence of an illness. Prediction of health events can include any health event as is known in the art. Health occurrences can include doctor visits, procedures performed, prescriptions, diagnoses, blood pressure or temperature readings. The one or more fields for health transactions in the time series data set can include a date, time, medication, diagnosis, procedure, reading type, reading value or any combination thereof.

The type of the event to be predicted can be an automotive event. Prediction of automotive event can include, for example, prediction a 1) component of a car breaking down, 2) a car coming to the end of its life, and/or 3) car requiring maintenance to avoid breakage in the future. Prediction of automotive event can include Automotive transactions can include a breakage to a component, a repair of a specific components or an event that triggers a breakage. The one or more fields for automotive transactions in the time series data set can include a date, time, owner, model type, maintenance type, maintenance frequency, repair type, repair frequency, breakage event, or any combination thereof.

The type of the event to be predicted can be an entertainment (e.g., sports) event. Prediction of entertainment events can include predicting the likelihood of a given athlete performing a certain action in the future that they had consistency and regularly performed in the past. Prediction of entertainment events can be any event as is known in the art. Entertainment occurrences can include any recording sport statistics. The one or more fields for entertainment occurrences in the time series data set can include a date, time, frequency and type of statistic (e.g., touchdowns scored, passes intercepted, field goals attempted/made), or any combination thereof.

Geographical events can include events such as repeated travel to specific locations: going to the gym, visiting a relative, commuting to work or traveling on weekends to a vacation home.

In some embodiments, the timeseries data set is for a given time period. The given time period can be a discrete time period. The given time period can be input by a user. The given time period can be dependent upon a type of event to be predication and/or prior occurrences. For example, for a type of event to be predicted is a financial transaction and the prior occurrences are prior financial transactions the given time period can be one day, one week or one month. In another example, for a type of event to be predicted is geographical event of commuting to work, the given time period can be one day. In another example, for a type of event to be predicted of internet site visited, the given time period can be a four hour period or a twelve hour period.

The method can also involve grouping, by the computing device, all prior occurrences by the time field or the date field (Step 220).

The method can also involve grouping, by the computing device, all prior occurrences by a first field of the plurality of fields (Step 230). The first field can be any field that the prior occurrences are grouped by, and/or one or more fields that are the same as the future event that are desired to predict. For example, for financial transactions, the prior occurrences can include coffee shop purchases, rent payments and clothing purchases. The first field can be any of coffee shop purchases, rent payments or clothing purchases.

The method can also involve tagging, by the computing device, all of the prior occurrences with a date that is the most recent prior incidence of an occurrence having a same field of the plurality of fields (Step 240). For example, assume three prior occurrences of financial transactions having type of coffee shop purchases all on different days, Jan. 13, 2021, Jan. 19, 2021, and Jan. 23, 2021. In this example, the group of coffee shop purchases is tagged with Jan. 23, 2021.

The method can also involve determining, by the computing device, for each same field of the plurality of fields, a set of factors, wherein the set of factors is based on date of the occurrence (Step 250).

In some embodiments, the prior occurrences are prior transactions and the method can also involve summing an amount for each group of prior transactions on a single date to create a group of single date transactions that includes one transaction per date and one amount per date.

In some embodiments, the set of factors is based on occurrence type. For example, if the occurrence type is financial transaction, the set of factors can include a number of transactions, an average of all transactions for the merchant, a variance for all transactions of the merchant, an average day span between transactions for the merchant, a variance for the average day span between transactions, a day of a week the transactions occurred, a variance in the day of the week the transaction occurred, a day of a month the transactions occurred, and/or a variance in the day of the week the transaction occurred.

The method can also involve determining, by the computing device, one or more desired predicted future events, the one or more desired predicted future events based on the set of factors (Step 260).

In various embodiments, the detected future events (e.g., a projected future event that it is desired to predict) includes a projected repeat transaction amount and/or a transaction interval. The transaction interval can include a particular day of the week or month projected for the transactions to occur.

As described above in FIG. 1, in some embodiments the time series data is stored in a time series database in a SQL server. The time series database can be a SQL database table with the time series data and a list of columns from the table. Each column can tagged as a date column, a group-by column or a value column. In some embodiments, an SQL query can identify recurring groups in the table and an SQL function to predict the future occurrences of any group.

The following functions of SQL can be used: common table expressions, partitioned window functions, date functions and/or aggregate functions. A mean and coefficient of variant can be determined for each date.

In these embodiments, the time series data can be in a table form. Each entre in table can include one or more fields. The SQL server can include a set of cascading Common Table Expressions (CTEs), which can analyze the data.

The CTEs can include:
CTE_TransactionByActivityDate: prior occurrences that are on the same day and have the same value in the group identifying fields can be combined into one row and their values in the numeric fields to be predicted can be summed;
CTE_AttachPriorActivityDate: tag_each table entry with the most recent occurrence prior to the event to be predicted date.
CTE_TransactionGroupStatistics: determining time series data statistics including the number of occurrences, the mean value and the coefficient of variation based on a group of identifying columns.
CTE_TransactionGroupFeatures: filtering grouped statistics based on respective coefficients of variation. Any mean value with a high coefficient of variation can be discarded. For example, for a financial transaction, for a days span, a high coefficient of variation can be 0.30. In some embodiments, mean values are rounded to whole numbers. In various embodiments, additional filters are applied. For example, a filter for filtering semi-monthly events which require looking at multiple statistics and even requires some moderate level of variance. For example, days in a span can be between 13.5 and 16.5, variation of days in a span can be between 0.1 and 0.3, and variation of days of a week can be greater than 0.29. In some embodiments, each group is tagged as active or inactive by comparing the number of days since last date occurrence/the mean number of days between occurrence to a threshold (e.g., a threshold that is input by the user). In some embodiments, the threshold is 1.3. In some embodiments, groups that are long overdue are considered inactive. In some embodiments, after the first set of groups are identified, there are some groups with less than 3 occurrences, a high coefficient of variation for the number of days since prior event and/or flagged as inactive. These groups can be deemed as not distinct recurring event groups. In various embodiments, any transactions covered by aforementioned groups are reprocessed to, for example, discover additional recurring patterns. Returning to CTE_TransactionGroupStatistics, the additional groupings can be created by removing one or more the of the grouping columns. This step can be repeated multiple times for each combination of grouping columns in diminishing levels of constraint.
CTE_Projections: Groups with at least 3 occurrences, a low coefficient of variation for the number of days since prior event and flagged as active can be deemed distinct recurring event groups. The remaining groups can be reduced to one row. Recurring group values can be set to null, mean days between occurrences is set to 1, and values to be projected can be calculated as daily averages.

Using the coefficient of variance and SQL features can allow for elimination of batch processing of time series data and performance real time (or near real-time) operation and determinations.

As described above, in some embodiments, the events to be predicted are financial transactions. In some embodiments, the events to be predicted can be determined based on the time series data. For example, for financial transactions, the category of transactions in the time series data can be used a the events to be predicted. For example, if the category of transactions includes dining, mortgage payments, and clothing, the events to be predicted can be dining, mortgage payments, and clothing. The desired event to be predicted can be determined automatically, can be requested by the user, or can be administrator input. In the case of administrator input, an administrator can determine for a first bank user that is a restaurant owner the desired events to be predicted are set A and for a second bank user that is an automotive repair shop the desire events to be predicted are set B, where set A and set B are different.

For financial transactions, while projections can be calculated at any interval of time (e.g. monthly, per quarter, semi-annually or annually). For example, if the interval of time is annually, seasonality can be leveraged as an additional input to accurately predict if an event is likely to occur again (e.g. higher spending habits every December or during Summer months). In these embodiments, the data from the period before (e.g. December from the year before) is analyzed to predict a more accurate average daily spend rate.

In some embodiments, to determine monthly seasonality, monthly (M) actual amounts of a specific recurring transactions or average spend rate can be compared to an actual monthly average amount (A). In some embodiments, the projected amount for a month is multiplied by M/A. In this manner, the monthly idiosyncrasies can be adjusted for.

For example, assume that the desired event to be projected is a seasonally adjusted utility bill for November, then the desired even to be predicted can be determined as shown in Table 1:

TABLE 1

(M) Utility Bills for the prior 2 Novembers: $60, $90
(A) Average Monthly Utility bills for prior 2 years: $180, $240
(M/A) Average ($60/$180 and $90/$240) = .35
Given a Projected Amount = $200
Seasonally Adjusted Projected Amount = .35 * $200 = $70

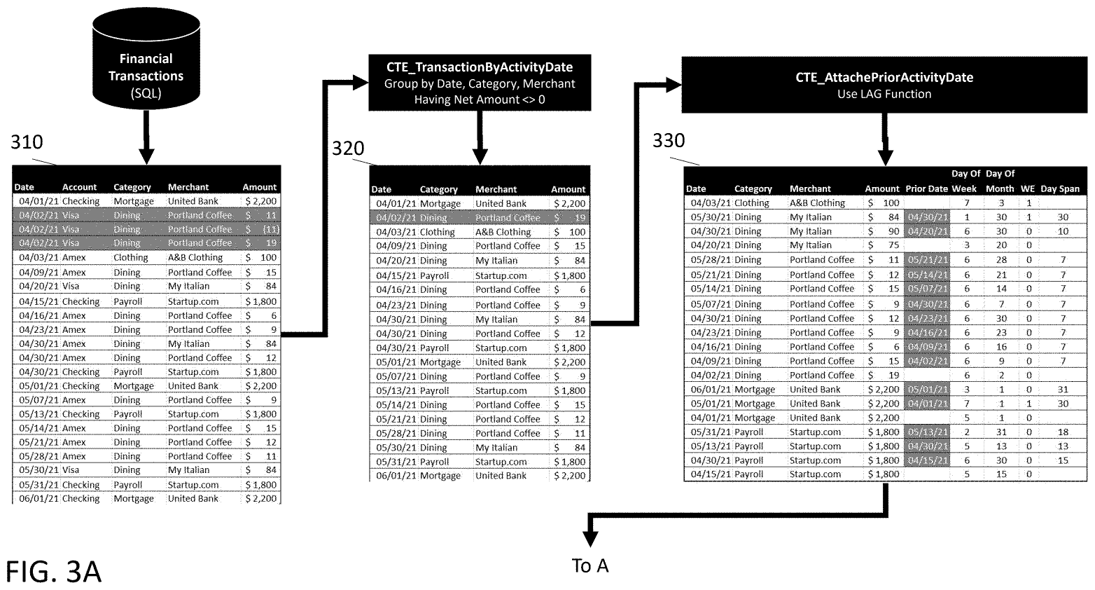

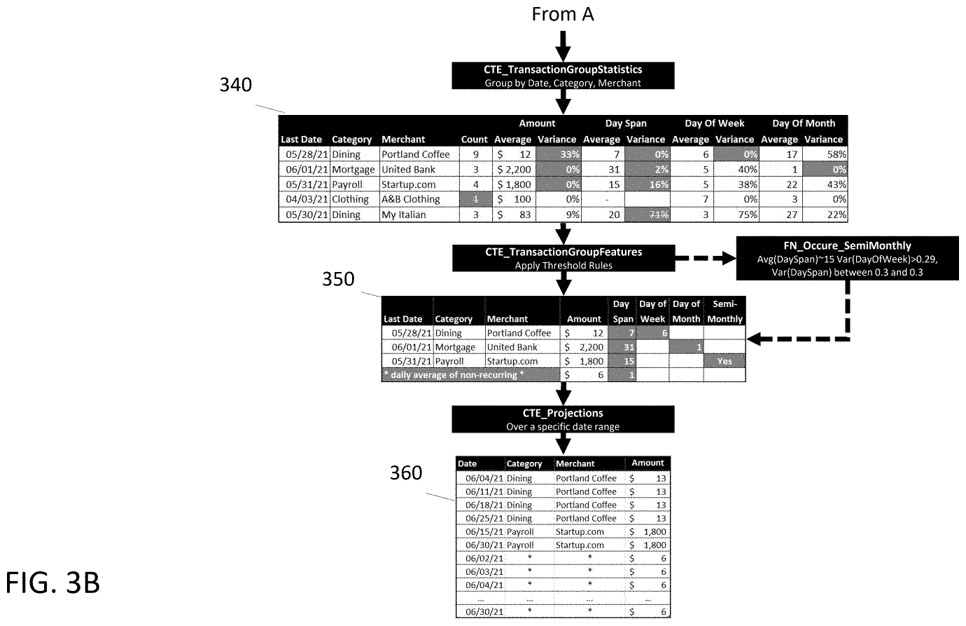

FIG. 3A and FIG. 3B are diagrams showing an example of automatically detecting future events for a particular user, according to an illustrative embodiment of the invention. As shown in FIGS. 3A and 3B, the time series data is financial transactions over three months. Time series data of financial transactions can be grouped by date and merchant type. For example, as shown in table 310, all transactions for Portland coffee on Apr. 2, 2021 are grouped and combined into one transaction as show in table 320. The transactions for Portland coffee on Apr. 2, 2021 are combined resulting in a net value of $19, as shown in table 320.

Each transaction is assigned a date of a prior similar transaction. For Portland coffee on Apr. 2, 2021, it can be seen in table 330 that nothing is assigned as there is no prior similar transaction, however for Portland coffee on Apr. 9, 2021, the prior transaction date of Apr. 2, 1921 is assigned. Each merchant is collapsed into one row, as shown in table 340. For example, Portland coffee is collapsed into the first row, showing there were 9 transactions (e.g., 9 counts), averaging $12 dollars, with a variance of 33%, an average day span of 7 days between transactions with no variance, and occurring on average the 17th day of the month with a variance of 58%.

The collapsed transaction rows are filtered (e.g., as discussed above in FIG. 2), removing any transaction with a day span variance above 30% or occurring less than three times. In this example, any transactions that have not occurred three times are filtered out, which causes the row on Apr. 3, 2021, A&B clothing transaction to be filtered out. The transaction on May 30, 2021, My Italian has a day span variance of 71% which causes it to be filtered out.

The time series data in the filtered table 350 is the data used to predict the future transactions. Because the table 350 includes merchant Portland coffee, United Bank, and Startup.com, the desired events to be predicted are future payments for Portland coffee, United Bank, and Startup.com. The desired events are predicted as shown in table 360 are determined. The dates of future events can be predicted by adding an average DaySpan to the last date of an occurrence and adjusting the new date according to other attributes which have a low variance.

As shown in the example of FIGS. 3A and 3B, United Bank transaction last occurred on Jun. 1, 2022 and adding the average DaySpan of 31 days yields a prediction of Jul. 2, 2022 but since the DayOfMonth average of Day 1 has a low variance, the date can be adjusted to the closest 1st of a month yielding Jul. 1, 2022. The value predicted is the dollar amount. In this example, the average amount is predicted to be $2,200. Other versions may use any other statistical function including but not limited to most recent amount, maximum amount, and/or seasonally adjusted amount.

Predicting and identifying specific transactions as they occur can be key to allowing for proper adjustments to the projected spending. Projections can adjust by recognizing early or timely execution of anticipated transactions to avoid double counting and/or overdue transactions can continue to be anticipated until the system automatically determines the pattern is no longer valid.

Only then can past spending be combined with project spending to provide an accurate estimate for a period's total projected spend. Thus, informing the consumer of their “safe to spend” or “need to reduce amount”.

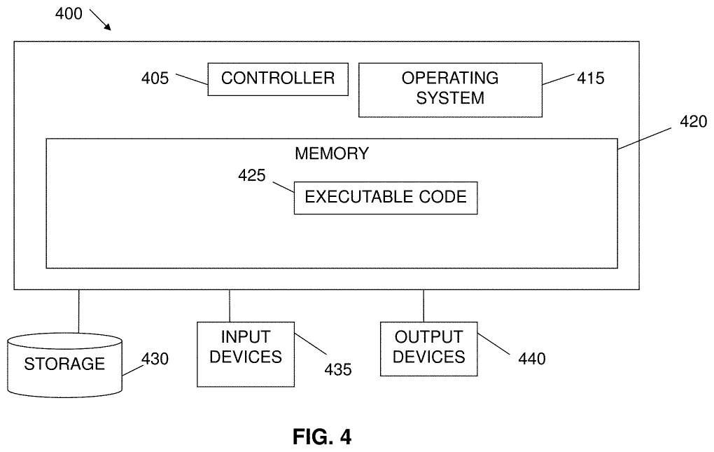

FIG. 4 shows a block diagram of a computing device 400 which can be used with embodiments of the invention. Computing device 400 can include a controller or processor 405 that can be or include, for example, one or more central processing unit processor(s) (CPU), one or more Graphics Processing Unit(s) (GPU or GPGPU), a chip or any suitable computing or computational device, an operating system 415, a memory 420, a storage 430, input devices 435 and output devices 440.

Operating system 415 can be or can include any code segment designed and/or configured to perform tasks involving coordination, scheduling, arbitration, supervising, controlling or otherwise managing operation of computing device 400, for example, scheduling execution of programs. Memory 420 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 can be or can include a plurality of, possibly different memory units. Memory 420 can store for example, instructions to carry out a method (e.g. code 425), and/or data such as user responses, interruptions, etc.

Executable code 425 can be any executable code, e.g., an application, a program, a process, task or script. Executable code 425 can be executed by controller 405 possibly under control of operating system 415. For example, executable code 425 can when executed cause masking of personally identifiable information (PII), according to embodiments of the invention. In some embodiments, more than one computing device 400 or components of device 400 can be used for multiple functions described herein. For the various modules and functions described herein, one or more computing devices 400 or components of computing device 400 can be used. Devices that include components similar or different to those included in computing device 400 can be used, and can be connected to a network and used as a system. One or more processor(s) 405 can be configured to carry out embodiments of the invention by for example executing software or code. Storage 330 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 430 and can be loaded from storage 430 into a memory 420 where it can be processed by controller 405. In some embodiments, some of the components shown in FIG. 3 can be omitted.

Input devices 435 can be or can include for example a mouse, a keyboard, a touch screen or pad or any suitable input device. It will be recognized that any suitable number of input devices can be operatively connected to computing device 400 as shown by block 435. Output devices 440 can include one or more displays, speakers and/or any other suitable output devices. It will be recognized that any suitable number of output devices can be operatively connected to computing device 400 as shown by block 440. Any applicable input/output (I/O) devices can be connected to computing device 400, for example, a wired or wireless network interface card (NIC), a modem, printer or facsimile machine, a universal serial bus (USB) device or external hard drive can be included in input devices 435 and/or output devices 440.

Embodiments of the invention can include one or more article(s) (e.g. memory 420 or storage 430) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A method for determining in real-time predicting future events for a particular user based on prior occurrences of the particular user, the method comprising:
receiving, by a computing device, in real-time a timeseries data set of prior occurrences for the particular user, each prior occurrence having a plurality of fields including a time field, a date field or both;
grouping, by the computing device, in real-time all prior occurrences of the particular user by the time field or the date field;
grouping, by the computing device, in real-time all prior occurrences of the particular user by a first field of the plurality of fields;
determining, by the computing device, in real-time a span between each prior occurrence of all prior occurrences of the user and the most recent prior incidence of the occurrence having the same field of the plurality fields by tagging all of the prior occurrences of the particular user with a date, time or both that is the most recent prior incidence of an occurrence having the same field of the plurality of fields;
determining, by the computing device, in real-time for each same field of the plurality of fields, a set of factors, wherein the set of factors is at least based on a number of the plurality of fields that has the same field and the respective span;
determining, by the computing device, in real-time one or more desired predicted future events for the particular user, the one or more desired predicted future events based on the set of factors; and
outputting, by the computing device, in real-time the one or more desired predicted future events for the particular user to a display.

2. The method of claim 1 wherein the first field of the plurality of fields includes one or more fields that the prior occurrences are grouped by, one or more fields that are the same as the future event that are desired to predict, or any combination thereof.

3. The method of claim 1 wherein the plurality of fields comprises a date, an amount, a category, or any combination thereof.

4. The method of claim 1 wherein the prior occurrences are prior transactions and further comprising summing, by the computing device, an amount for each group of prior transactions on a single date to create a group of single date transactions that includes one transaction per date and one amount per date.

5. The method of claim 1 wherein the set of factors is further based on occurrence type, transaction type, event type, or any combination thereof.

6. The method of claim 1 wherein the plurality of fields includes a merchant.

7. The method of claim 6 wherein the prior occurrences are prior transactions and wherein the set of factors includes a number of transactions, an average of all transactions for the merchant, a variance for all transactions of the merchant, an average day span between transactions for the merchant, a variance for the average day span between transactions, a day of a week the transactions occurred, a variance in the day of the week the transaction occurred, a day of a month the transactions occurred, and a variance in the day of the week the transaction occurred, or any combination thereof.

8. The method of claim 1 wherein the desired projected future events include a projected repeat transaction amount, a transaction interval, or any combination thereof.

9. The method of claim 8 wherein a transaction interval further comprises a particular day of the week or month projected for the transactions to occur.

10. A method for determining predicting future events based on prior transactions, the method comprising:
receiving, by a computing device, a timeseries data set of prior transactions, each prior transaction having a date, an amount, a category, a merchant, or any combination thereof;
grouping, by the computing device, all prior transactions having the same date;
tagging, by the computing device, all of the prior transactions with a date that is the most recent prior incidence of a transaction having a same merchant;
determining, by the computing device, for each merchant, a set of factors based on the tagged prior transactions, wherein the set of factors includes a number of transactions, an average of all transactions for the merchant, a variance for all transactions of the merchant, an average day span between transactions for the merchant, a variance for the average day span between transactions, a day of a week the transactions occurred, a variance in the day of the week the transaction occurred, a day of a month the transactions occurred, and a variance in the day of the week the transaction occurred, or any combination thereof; and
determining, by the computing device, for each merchant a projected repeat transaction amount, a transaction interval, or any combination thereof based on the set of factors.

11. (canceled)

12. (canceled)

13. A non-transitory computer program product comprising instructions which, when the program is executed cause the program to:
receive in real-time a timeseries data set of prior occurrences for the particular user, each prior occurrence having a plurality of fields including a time field, a date field or both;
group in real-time all prior occurrences of the particular user by the time field or the date field;
group in real-time all prior occurrences of the particular user by a first field of the plurality of fields;
determine in real-time a span between each prior occurrence of all prior occurrences of the user and the most recent prior incidence of the occurrence having the same field of the plurality fields by tagging, all of the prior occurrences of the particular user with a date, time or both that is the most recent prior incidence of an occurrence having the same field of the plurality of fields;
determine in real-time for each same field of the plurality of fields, a set of factors, wherein the set of factors is at least based on a number of the plurality of fields that has the same field and the respective span;
determine in real-time one or more desired predicted future events for the particular user, the one or more desired predicted future events based on the set of factors; and
output in real-time the one or more desired predicted future events for the particular user to a display.

14. The non-transitory computer program product of claim 13 wherein the first field of the plurality of fields includes one or more fields that the prior occurrences are grouped by, one or more fields that are the same as the future event that are desired to predict, or any combination thereof.

15. The non-transitory computer program product of claim 13 wherein the plurality of fields comprises a date, an amount, a category, or any combination thereof.

16. The non-transitory computer program product of claim 13 wherein the prior occurrences are prior transactions and further comprising summing, by the computing device, an amount for each group of prior transactions on a single date to create a group of single date transactions that includes one transaction per date and one amount per date.

17. The non-transitory computer program product of claim 13 wherein the set of factors is further based on occurrence type, transaction type, event type, or any combination thereof.

18. The non-transitory computer program product of claim 13 wherein the plurality of fields includes a merchant.

19. The non-transitory computer program product of claim 13 wherein the prior occurrences are prior transactions and wherein the set of factors includes a number of transactions, an average of all transactions for the merchant, a variance for all transactions of the merchant, an average day span between transactions for the merchant, a variance for the average day span between transactions, a day of a week the transactions occurred, a variance in the day of the week the transaction occurred, a day of a month the transactions occurred, and a variance in the day of the week the transaction occurred, or any combination thereof.

20. The non-transitory computer program product of claim 13 wherein the desired projected future events include a projected repeat transaction amount, a transaction interval, or any combination thereof.

21. The non-transitory computer program product of claim 13 wherein a transaction interval further comprises a particular day of the week or month projected for the transactions to occur.

22. The method of claim 1 wherein the predicted future event is a projected repeat transaction interval, the prior occurrences are prior transactions, and the set of factors includes a variation for day spans, and further comprising determining the projected repeated transaction interval by:
filtering groups of prior occurrences grouped by the same field if there are less then a predefined threshold of occurrences in the group;
filtering groups of prior occurrences grouped by the same field having a coefficients of variation of spans greater then a predefined threshold; and
determining the projected repeat transaction interval for each non-filtered group of prior occurrences grouped by the same field by averaging the spans within the group and setting the projected repeat transaction interval to the average.

23. The method of claim 1 further comprising determining for each same field of the plurality of fields, that a recurring occurrence is inactive by determining whether a number of days since a prior occurrence is above a predetermined group threshold.
